(19) United States
(12) Patent Application Publication
(10) Pub. No.: US 2013/0190463 A1
(43) Pub. Date: Jul. 25, 2013

(54) WATER SOLUBLE BIODEGRADABLE POLYMER AND PROCESS FOR PREPARATION THEREOF

(71) Applicants: Subramaniam Radhakrishnan, Pune (IN); Prasad Vithal Kulkarni, Pune (IN)

(72) Inventors: Subramaniam Radhakrishnan, Pune (IN); Prasad Vithal Kulkarni, Pune (IN)

(73) Assignee: AQUAPHARM CHEMICALS PVT LIMITED, Pune (IN)

(21) Appl. No.: 13/825,485

(22) PCT Filed: Sep. 23, 2011
(86) PCT No.: PCT/IN2011/000661

§ 371 Date: Mar. 21, 2013

(30) Foreign Application Priority Data
Sep. 27, 2010 (IN) 2664/MUM/2010

(51) Int. Cl. C08F 230/02

(52) U.S. Cl. CPC C08F 230/02
USPC 526/75

(57) ABSTRACT

A water soluble biodegradable polymer and a process for preparation thereof are disclosed. The polymer has characteristic NMR and FTIR peaks. The polymer is prepared by a process including preparing a mixture of phosphatides and triglycerides, reacting the mixture with an anhydride in an organic solvent in presence of a catalyst at an elevated temperature to obtain a reaction product, hydrolyzing the reaction product, thereafter separating the organic solvent from the reaction product, adding a second monomer with a catalyst to form a reaction mass, further curing the mass under stirring at reflux temperature, and finally cooling the cured mass and neutralizing it with caustic lye to obtain the polymer. The polymer is biodegradable and has high calcium sequestration and calcium salt inhibition properties suitable as an additive for detergents and water treatment applications.

### FIELD OF THE INVENTION

The present invention relates to biodegradable polymers and, more particularly, to biodegradable water soluble polymers capable of being used in water treatment and related applications, and process for preparation thereof.

### BACKGROUND OF THE INVENTION

Water soluble polymers are used extensively in various areas such as water treatment, detergents and textiles. Few patents are available on biodegradable polymers based on aspartic acid and succinic acid and citing use thereof for the water treatment (anti-scaling) and in detergents.

Specifically, U.S. Pat. No. 5,594,077 describes a process for synthesis of polyaspartic acid which includes reacting maleic anhydride with ammonia at high temperature (110° to 180° C.) and high pressure (20 to 30 bar) to prepare an adduct which is subsequently polymerized at 170° to 180° C. in specially designed reactor to obtain the product.

Further, U.S. Pat. No. 6,686,440 and all the references cited therein describe various processes and special equipment used for synthesis of polymers and co-polymers with aspartic acid and its derivatives. The polymers obtained by use of the process of aforementioned patents have been claimed to be readily biodegradable and good antiscalants. However, various reports on the performance of polyaspartic acid or its derivatives as antiscalant indicate that these are not as good as polyacrylic acid or copolymers of acrylic acid (Ref M. Shweinberg et al Proc. IWC 2003; Yonghong et al J. Environ. Sci. Vol. 21 (1), P. S73). Polyacrylic acid in a typical detergent formulation gives incrustation of 1.3 while polyaspartic acid gives the incrustation of 1.72. The calcium inhibition value tested under NACE standard for the polyacrylic acid is 90% whereas for the polyaspartic acid, the calcium inhibition value is only 78%.

Major drawbacks of the prior art processes are that they requires high temperature, high pressure and special equipments which causes ammonia leakage and which are not environmentally safe.

Further, effects of the detergent and its component on environment have been of concern over the years and it has mainly come in focus in recent years. Accordingly, use of phosphates and other chelating agents in detergents has been particularly restricted by various regulatory authorities and environmental protecting agencies. Conventionally, polymers have been used in detergents as builders/co-builders for enhancing the performance of the detergents. Various polymers such as polyacrylic acid, co-polymers of acrylic and maleic acid, and their sodium salts, co-polymers of acrylic acid with styrene are used in detergents as builders/co-builders. All the aforementioned polymers are well documented in literature (Handbook of Detergents Part D, Ed. M. S. Showell, CRC Press 2005 Ch. 1; P. Zini, Polymeric additives for high performance detergents, Technomic Pub. Co. 1995) and patents covering processes of their synthesis. Further, use of these polymers in the detergent applications is published in various journals (J. Surfactants & Detergents), patent databases, and handbooks. However, all the aforementioned polymers are not biodegradable and therefore are not eco-friendly (S. Mastumura et al, Polym. Degrad. Stab. Vol. 45, P. 233-239). Specifically, the polymers made by prior art processes when used in detergents, leads to accumulation in sludge and environmental pollution. Accordingly, efforts have been made in recent past to synthesize biodegradable polymers.

Accordingly, there exists a need for a water soluble polymer having eco-friendly properties. Further, there exists a need for a water soluble polymer which may be used as additive in detergent formulations. Furthermore, there exists a need to provide a process for synthesis of water soluble polymer using non-hazardous chemicals and materials.

### OBJECTS OF THE INVENTION

An object of the present invention is to provide a water soluble polymer having biodegradable property

Another object of the present invention is to provide a water soluble polymer, which may be used as a builder/co-builder in detergent formulations and water treatment as calcium salt inhibitor.

Yet another object of the present invention is to provide a process for preparation of water soluble biodegradable polymer by using non-hazardous chemicals and materials.

### SUMMARY OF THE INVENTION

According to the present invention, there is provided a water soluble biodegradable polymer for inhibition and sequestration of calcium salt in detergent and water treatment applications prepared by a process comprising:

preparing a mixture of phosphatide and triglyceride;

reacting the mixture of the phosphatide and the triglyceride with an anhydride in an organic solvent with a first catalyst at an elevated temperature in the range of 90° C. to 160° C. for a duration ranging from for one to three hours to form a reaction product;

hydrolyzing the reaction product;

separating solvent from the reaction product;

adding a second monomer along with a second catalyst to the separated reaction product to form a reaction mass;

curing the reaction mass under stirring at a reflux temperature for one to three hours to form a reaction mixture; and

cooling the reaction mixture and neutralizing the reaction mixture with caustic to obtain the water soluble biodegradable polymer.

Typically, wherein the phosphatide is selected from a group consisting of phosphatidyl-choline, phosphatidyl-ethanol amine, phosphatidyl-inositol and phosphatilic acid in the range of 5 to 25 wt %.

Typically, wherein the triglyceride is selected from a group consisting of palmitic acid, stearic acid, oleic acid, linoleic acid and alpha-linolenic acid in the range of 5 to 39 wt %.

Typically, wherein the anhydride is selected from a group consisting of maleic anhydride, succinic anhydride and phthalic anhydride.

Typically, wherein the organic solvent is high boiling non polar solvent having boiling point in the range of 90° to 160° C.

Typically, wherein the first catalyst used for the reaction is selected from a group consisting of 2,5-Dimethyl-2,5-di t-butylperoxy hexane, t-butylperoxy-2-ethylhexanoate, t-butylperoxy benzoate, di-t-butyl peroxide and hydrogen peroxide.

Typically, wherein, the second monomer is selected from a group consisting of acrylic acid, methacrylic acid and other carboxylic acids having conjugated unsaturated bond.

Typically, wherein the second catalyst is selected from a group consisting of potassium per sulfate, ammonium per sulfate, lewis acids, hydrogen peroxide and other similar free radical initiators.

Typically, wherein the phosphatide and triglyceride is obtained from natural sources such as soya, sunflower and wheat germ.

In an embodiment of the present invention, there is provided a process for preparation of water soluble biodegradable polymer for calcium salt inhibition and sequestration in detergent and water treatment applications, the process comprising:

preparing a mixture of phosphatide and triglyceride;

reacting the mixture of the phosphatide and the triglyceride with an anhydride in an organic solvent with a first catalyst at an elevated temperature in the range of 100° C. to 160° C. for a duration ranging from for one to three hours to form a reaction product;

hydrolyzing the reaction product;

separating solvent from the reaction product;

adding a second monomer along with a second catalyst to the separated reaction product to form a reaction mass;

curing the reaction mass under stirring at a reflux temperature for one to three hours to form a reaction mixture; and

cooling the reaction mixture and neutralizing the reaction mixture with caustic to obtain the water soluble biodegradable polymer.

Typically, wherein the phosphatide is selected from a group consisting of phosphatidyl-choline, phosphatidyl-ethanol amine, phosphatidyl-inositol and phosphatilic acid in the range of 5 to 25 wt %.

Typically, wherein the triglyceride is selected from a group consisting of palmitic acid, stearic acid, oleic acid, linoleic acid and alpha-linolenic acid in the range of 5 to 39 wt %.

Typically, wherein the anhydride is selected from a group consisting of maleic anhydride, succinic anhydride and phthalic anhydride.

Typically, wherein the organic solvent is high boiling non polar solvent having boiling point in the range of 900 to 1600 C.

Typically, wherein the first catalyst used for the reaction is selected from a group consisting of 2,5-Dimethyl-2,5-di t-butylperoxy hexane, t-butylperoxy-2-ethylhexanoate, t-butylperoxy benzoate, di-t-butyl peroxide and hydrogen peroxide.

Typically, wherein, the second monomer is selected from a group consisting of acrylic acid, methacrylic acid and other carboxylic acids having conjugated unsaturated bond.

Typically, wherein the second catalyst is selected from a group consisting of potassium per sulfate, ammonium per sulfate, lewis acids, hydrogen peroxide and other similar free radical initiators.

Typically, wherein the phosphatide and triglyceride is obtained from natural sources such as soya, sunflower and wheat germ.

### BRIEF DESCRIPTION OF THE DRAWINGS

FIG. 1 shows 1H NMR peaks for a water soluble biodegradable polymer in accordance with the present invention;

FIG. 2 shows 13C NMR peaks for the water soluble biodegradable polymer in accordance with the present invention;

FIG. 3 shows FTIR peaks for the water soluble biodegradable polymer with the present invention; and

FIG. 4 shows a flowchart for a process for preparation of water soluble biodegradable polymer in accordance with the present invention;

### DETAIL DESCRIPTION OF THE INVENTION

The foregoing objects of the present invention are accomplished and the problems and shortcomings associated with the prior art, techniques and approaches are overcome by the present invention as described below in the preferred embodiments. Accordingly, the present invention provides a water soluble polymer for inhibition and sequestration of calcium salt in detergent and water treatment applications, and a process of preparation thereof. The water soluble polymer has biodegradable property and can be used as a builder/co-builder in detergent formulations. Furthermore, the water soluble biodegradable polymer can be prepared by using non-hazardous chemicals and materials.

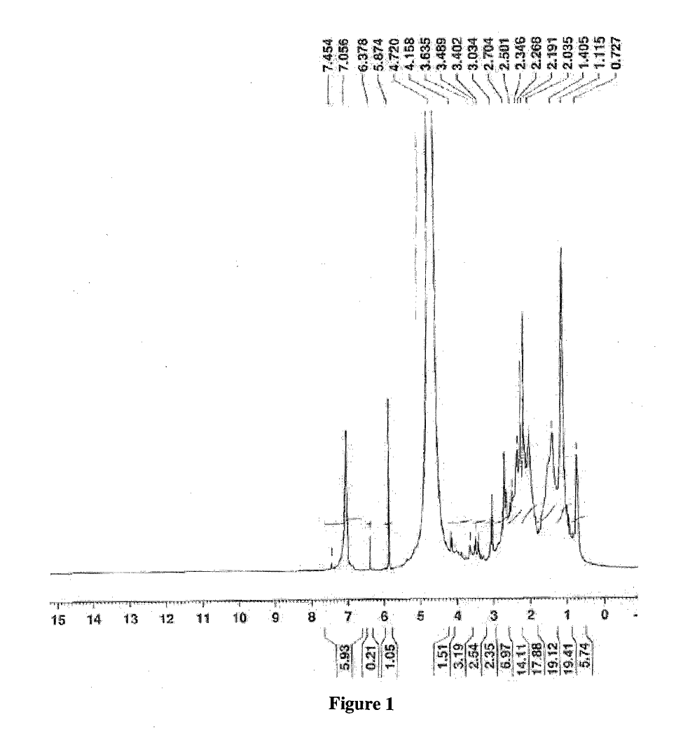

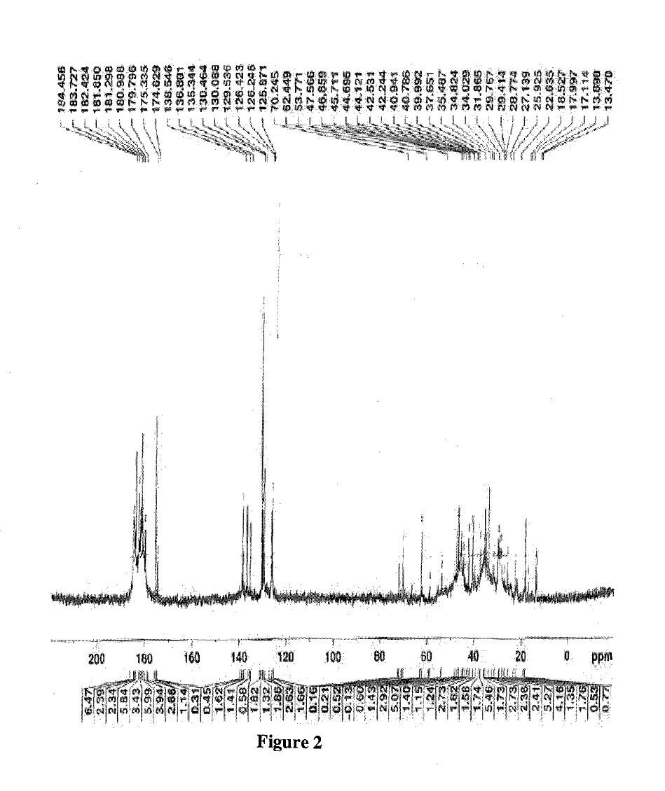

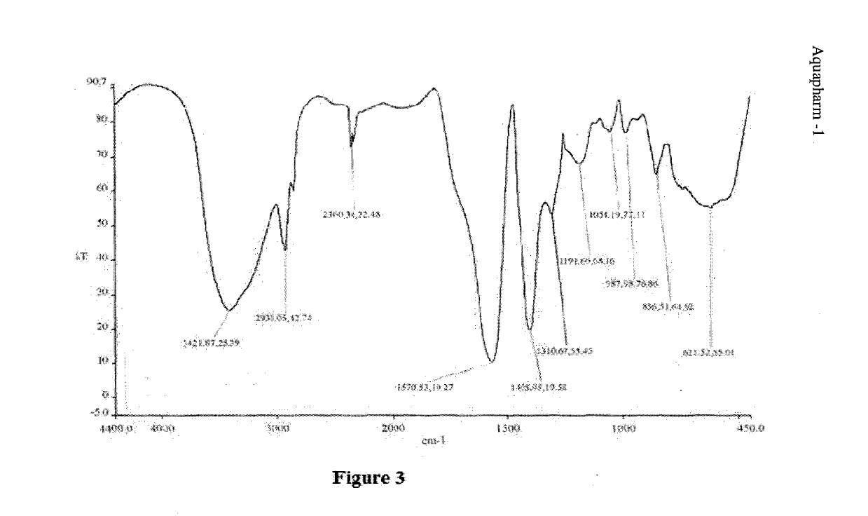

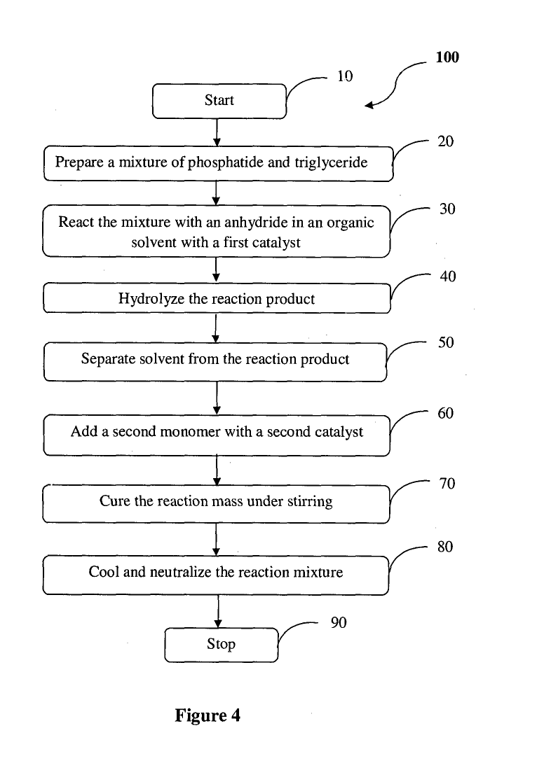

Referring now to FIGS. 1, 2 3 and 4, characteristic NMR and FTIR peaks for a water soluble biodegradable polymer useful for inhibition and sequestration of calcium salt in detergent and water treatment applications and a process for preparation for the water soluble biodegradable polymer is illustrated in accordance with the present invention. Specifically, FIGS. 1 and 2 shows characteristic ¹H NMR peaks and ¹³C NMR peaks respectively for the water soluble biodegradable polymer of the present invention. Further, the FIG. 3 shows characteristic FTIR peaks for the water soluble biodegradable polymer of the present invention. Furthermore, FIG. 4 illustrates a process for the preparation water soluble biodegradable polymer in accordance with the present invention.

Specifically, the water soluble biodegradable polymer of the present invention which is identified by characteristic peaks obtained by Nuclear Magnetic Resonance (NMR) and Fourier Transform Infrared Spectroscopy (FTIR) are shown in FIGS. 1, 2, and 3 having values as follows.

| 1H NMR Delta ppm | 13C NMR Delta ppm | FTIR Frequency cm⁻¹ |
|---|---|---|
| 1.11 | 13.47, 13.89 | 3410-3412 |
| 1.40 | 17.11, 17.99 | 2929-2930 |
| 2.03 | 18.52 | 1640-1644 |
| 2.19 | 22.63 | 1570-1573 |
| 2.26 | 25.92 | 1406-1410 |
| 2.34 | 27.14 | 1310-1312 |
| 2.50 | 28.77 | 1189-1192 |
| 2.70 | 29.41, 29.76 | 995-997 |
| 2.94 | 31.86 | 858-859 |
| 3.03 | 34.03, 34.82 | 622-625 |
| 3.40 | 35.48 | |
| 3.48 | 37.65 | |
| 3.63 | 39.99 | |
| 4.16 | 40.78, 40.94 | |
| 4.72 | 42.24, 42.53 | |
| 5.87 | 44.12, 44.69 | |
| 6.38 | 45.71 | |
| 7.05 | 46.86 | |
| 7.45 | 47.56, 47.56 | |
| | 53.77 | |
| | 62.45 | |
| | 70.25 | |
| | 125.87 | |
| | 126.24, 126.42 | |
| | 129.53 | |
| | 130.08, 130.46 | |
| | 135.34, 136.81 | |
| | 138.55 | |
| | 174.63 | |
| | 175.35 | |
| | 179.79, 180.9 | |
| | 181.29, 181.85 | |
| | 182.42 | |
| | 183.73 | |
| | 184.45 | |

NMR Delta ±0.1 ppm
FTIR Frequency ±5 cm⁻¹ for peak

The water soluble biodegradable polymer having the characteristic NMR and FTIR peaks as shown in FIGS. 1, 2 and 3 is prepared by the process (100) as illustrated in FIG. 4.

The process (100) starts at (10). At (20), the process (100) includes preparing a mixture of phosphatide and triglyceride. Specifically, the phosphatide is selected from a group consisting of phosphatidyl-choline, phosphatidyl-ethanol amine, phosphatidyl-inositol and phosphatilic acid in the range of 5 to 25 wt %. Further, the triglyceride is selected from a group consisting of palmitic acid, stearic acid, oleic acid, linoleic acid and alpha-linolenic acid in the range of 5 to 39 wt %.

At step (30), the process (100) includes reacting the mixture of the phosphatide and the triglyceride with an anhydride in an organic solvent with a first catalyst at an elevated temperature in the range of 100° C. to 160° C., preferably 120° C. to 140° C. for a duration ranging from for 1 to 3 hours to form a reaction product.

Specifically, the anhydride is selected from a group consisting of maleic anhydride, succinic anhydride and phthalic anhydride. Further, the organic solvent is a high boiling non polar solvent having boiling point in the range of 90° to 160° C. Furthermore, the first catalyst used for the reaction is selected from a group consisting of 2,5-Dimethyl-2,5-di t-butylperoxy hexane, t-butylperoxy-2-ethylhexanoate, t-butylperoxy benzoate, di-t-butyl peroxide and hydrogen peroxide.

At step (40), the process (100) includes hydrolyzing the reaction product obtained in step (30).

At step (50), the process (100) includes separating solvent from the reaction product.

At step (60), the process (100) includes adding a second monomer along with a second catalyst to the separated reaction product to form a reaction mass. Specifically, the second monomer is selected from a group consisting of acrylic acid, methacrylic acid and other carboxylic acids having conjugated unsaturated bond.

At step (70), the process (100) includes curing the reaction mass under stirring at a reflux temperature for one to three hours to form a reaction mixture. Specifically, the second catalyst is selected from a group consisting of potassium per sulfate, ammonium per sulfate, lewis acids, hydrogen peroxide and other similar free radical initiators.

At step (80), the process (100) includes cooling the reaction mixture and neutralizing the reaction mixture with caustic to obtain the water soluble biodegradable polymer. The process (100) ends at step (90).

In an embodiment of the present invention, the mixture of phosphatide and triglyceride may be obtained as such from natural sources such as sunflower oil, soya bean, wheat germ, egg yolk and other bio-components.

In an embodiment of the present invention, there is provided a process for preparation of a water soluble biodegradable polymer. The process for preparation of water soluble biodegradable polymer is similar to what described in FIG. 4. Accordingly, for sake of brevity, the process is not described herein in detail. The water soluble biodegradable polymer of the present invention is obtained by the process described herein below with examples, which are illustrative only and should not be construed to limit the scope of the invention in any manner. The examples 1 to 4 illustrate the synthesis of the biodegradable polymer.

### Example 1

In a necked glass reactor, 230 gm o-xylene (98% purity) was taken to which 45.8 gm maleic anhydride and 30.5 gm mixture (A) with composition (A4) (Given in Table-1) obtained separately were added, and stirred vigorously until dissolved. The temperature of the reactor was raised to 65° to 70° C. and 0.76 gm of 2,5-Dimethyl-2,5-di-t-butylperoxy hexane was added. The reactor temperature was increased to 135° to 140° C. and reaction was carried out for 2 hrs after which the addition of 7.6 gm of di-tertiary butyl peroxide was started and completed within 4 hrs. The reaction mixture was further digested for 1 hr. The organic solvent (o-xylene) was siphoned out and 300 gm of pure water was added for hydrolysis which was carried at 100° to 105° C. Small traces of xylene were removed during azeotropic distillation to get a reaction mass. The reaction mass was then cooled to 50° C. and neutralized with 76 gm caustic lye (47%) to pH ranging between 7.0 to 7.2. The temperature of the reactor was again raised to 95° to 100° C. and the second monomer addition, specifically 40 gm acrylic acid together with 10 gm hydrogen peroxide was carried out at a linear rate and completed in 2 hr. The reaction mass was digested for 1 hr at 95° to 100° C. The reaction mass was then cooled to 35° to 40° C. which yielded 420 gm of the biodegradable polymer (40% solid) useful for detergent applications. The performance properties of the polymer obtained by the aforementioned process are given in Table-2, whereas the ingredient and composition of mixture (A) is given in Table-1 as follows.

TABLE 1
Ingredients and composition for mixture (A)

| | A1 | A2 | A3 | A4 |
|---|---|---|---|---|
| Phosphatydyl- | 13 | 18 | 14 | 23 |
| choline | | | | |
| Phosphatydyl- | 10 | 12 | 13 | 19 |
| ethanolamine | | | | |
| Phosphatydyl- | 10 | 15 | 12 | 14 |
| inositol | | | | |
| Phosphatylic | 12 | 5 | 8 | 7 |
| acid | | | | |
| Phospho lipids | 1 | 1 | 1 | 8 |
| Glycolipids | 11 | 10 | 9 | 14 |
| Triglycerides | 37 | 32 | 38 | 3 |
| Other matter | 6 | 7 | 5 | 10 |

### Example 2

In a glass reactor with reflux condenser, 460 gm o-xylene, 32 gm of mixture (A) with composition (A1) and 70 gm maleic anhydride were charged. The temperature of the reactor was raised up to 70° C. and 0.5 gm of 2,5-dimethyl-2,5-di t-butylperoxy hexane was added at once and the reaction mass was heated for 2 hrs at 130° to 135° C. At the end of 2 hours, the addition of second monomer i.e. acrylic acid (50 gm) and catalyst solution (7 gm of Di tertiary butyl peroxide in 10 gm o-xylene) addition was started and completed over 4 hrs. During the addition, temperature was maintained between 130° to 135° C. The reaction mass was cured for 2 hrs at 140° to 142° C. and then cooled to 90° C. 450 gm of pure water was added to the reaction mass and mixed well. The temperature of the reaction mass was raised to 100° to 105° C. and the hydrolysis reaction was carried out for 2 hrs. The reaction mixture was allowed to settle and the organic solvent was separated. The water from aqueous layer of the reaction mixture was distilled out to adjust solid content (reaction mass) to 43-44%. The reaction mass was then treated with 140 gm caustic solution to adjust the pH of 7.0 to 8.0 in the product which resulted in 430 gm of biodegradable polymer solution (40% solids) useful for detergent application. The performance properties of this polymer are indicated in Table-2.

### Example 3

A glass reactor with reflux condenser was charged with 920 gm of o-xylene, 64 gm of mixture (A) having composition (A3) (Given in Table-1) and 140 gm of maleic anhydride under stirring. The temperature of the reactor was raised up to 65° C. and 4.8 gm of mercaptoethanol was added and stirred continually. The temperature of the reactor was increased to 130° C. and the simultaneous addition of 100 gm of acrylic acid and 14 gm of ditertiary butyl peroxide solution was started over the period of 4 hrs. The temperature of the reactor was maintained between 130° to 135° C. throughout the addition. The reaction mixture was then cured for 1 hr at 130° to 135° C. After curing, the temperature was lowered and 1.0 kg of pure water was added to the reaction mixture for hydrolysis at 100° to 105° C. to obtain a product. The product was separated by standing for 1 hr and distillation of 600 gm water and xylene carried out. The reaction mixture was cooled to ambient temperature and neutralized using 280 gm of caustic lye (47%) to adjust the pH between 7.0 to 7.5 to obtain biodegradable polymer useful for detergent application. The performance properties of this polymer in detergent are given Table-2.

### Example 4

The water soluble biodegradable polymer was prepared in the same manner described in Example 2 except that the mixture (A) includes the composition (A2) indicated in Table-1 and obtained from extract of soya bean. The properties of this polymer are given in Table-2

Further, the use of the water soluble biodegradable polymer of the present invention in calcium inhibition, detergents and comparison of the biodegradable performance with other commercial polymers is illustrated below.

### Testing Performance of the Biodegradable Polymer of the Present Invention in Detergents:

All the polymers along with the commercially available polyacrylic acid based polymers were incorporated in detergent formulation (standard) and tested using Turgotometer for single wash and front loading washing machine (Europe standard) for multiple wash cycles. The detergent formulation was non-phosphate grade, used at 3 gm/liter. All the polymers were kept at 3 wt % of the detergent, water hardness was 150 ppm Ca as CaO3, cloth to water ratio was 1:100. Specifically, standard soiled cloth, white knitted fabric and blue fabric were used. Optical data was recorded after 10 wash cycle using front loading machine or 1 wash cycle using Turgotometer. Reflectance was measured using Premier Colorscan Spectrophotometer SS 5100A under D65 illuminant at 460 nm.

The data was used for estimation of soil removal efficiency, anti-soil redeposition and incrustation. Soil removal=Ra/Ro, where Ra is reflectance of soiled fabric after wash and Ro is reflectance of unsoiled fabric. The anti-soil redeposition indicated by the ratio [the whiteness after wash/whiteness of original fabric]×100. Incrustation is the ash content after incineration of fabric.

### Testing for Calcium Salt Inhibition:

The tests were performed under static bottle test using water hardness of 1000 ppm Ca as calcium carbonate with polymer dosage of 5 ppm and 10 ppm. The test conditions were 55° C. for 24 hours.

### Testing of Biodegradability:

The biodegradability of the polymers was tested according to OECD standard procedure using BOD (Lovibond) and COD (Spectralab) analyzers over 28 days.

TABLE 2
Performance of the polymers of the present invention for detergent and other features

| | | Anti-soil | Incrustation | Calcium* | |
|---|---|---|---|---|---|
| | Soil | redeposition | (Increase in | carbonate | |
| | removal | (% whiteness | ash | inhibition | |
| | Ra/Ro | retained of | compared | at ppm | Biodegradability |
| Sample | (%) | original cloth) | to original) | 5, 10 | Test** |
| Example 1 | 60 | 98 | 0.27 | 50, 67 | >50% |
| Example 2 | 56.3 | 94 | 0.49 | 42, 57 | 50% |
| Example 3 | 64.9 | 96 | 0.39 | 52, 64 | 50% |
| Example 4 | 70 | 98 | 0.52 | 45, 64 | >50% |
| Polyacrylic acid | 58.3 | 90.1 | 1.75 | 69, 76 | Nil |
| homopolymer | | | | | |
| (commercial) | | | | | |
| Acrylic acid | 61.3 | 85.4 | 4.39 | 11, 20 | 8% |
| Co-polymer | | | | | |
| (commercial) | | | | | |

*Tested under 1000 ppm calcium carbonate, 55° C., 24 hr static bottle test
**Static closed bottle test as per OECD 301 D screening test for 28 days

It is seen from the data given in Table-2 that the polymer of the present invention are not only biodegradable but also have better performance in detergent applications.

Further, the water soluble biodegradable polymer of the present invention has better calcium carbonate inhibition than the commercially available polymers used for detergent application. This property is useful in retaining color shade (without graying) after repeated washing cycles in colored clothing.

An advantage of the water soluble polymer of the present invention is that, the polymer is biodegradable and therefore is eco-friendly. Further, the polymer of the present invention inhibits and sequestrates calcium salt in detergent and water treatment applications and gives better performance when used in laundry detergents as compared to other commercially available polymers.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, to thereby enable others skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present invention.

1. A water soluble biodegradable polymer prepared by a process comprising:
preparing a mixture of phosphatide and triglyceride;
reacting the mixture of the phosphatide and the triglyceride with an anhydride in an organic solvent with a first catalyst at an elevated temperature in the range of 100° C. to 160° C. for a duration ranging from one to three hours to form a reaction product;
hydrolyzing the reaction product;
separating the organic solvent from the reaction product;
adding a second monomer along with a second catalyst to the separated reaction product to form a reaction mass;
curing the reaction mass under stirring at a reflux temperature ranging from one to three hours to form a reaction mixture; and
cooling the reaction mixture and neutralizing the reaction mixture with a caustic solution to obtain the water soluble biodegradable polymer.

2. The water soluble biodegradable polymer as claimed in claim 1, wherein the phosphatide is selected from a group consisting of phosphatidyl-choline, phosphatidyl-ethanol amine, phosphatidyl-inositol and phosphatilic acid in the range of 5 to 25 wt %.

3. The water soluble biodegradable polymer as claimed in claim 1, wherein the triglyceride is selected from a group consisting of palmitic acid, stearic acid, oleic acid, linoleic acid and alpha-linolenic acid in the range of 5 to 39 wt %.

4. The water soluble biodegradable polymer as claimed in claim 1, wherein the anhydride is selected from a group consisting of maleic anhydride, succinic anhydride and phthalic anhydride.

5. The water soluble biodegradable polymer as claimed in claim 1, wherein the organic solvent is a high boiling non polar solvent having a boiling point in the range of 90° to 160° C.

6. The water soluble biodegradable polymer as in claimed in claim 1, wherein the first catalyst is selected from a group consisting of 2,5-Dimethyl-2,5-di t-butylperoxy hexane, t-butylperoxy-2-ethylhexanoate, t-butylperoxy benzoate, di-t-butyl peroxide and hydrogen peroxide.

7. The water soluble biodegradable polymer as claimed in claim 1, wherein the second monomer is selected from a group consisting of acrylic acid, methacrylic acid and other carboxylic acids having a conjugated unsaturated bond.

8. The water soluble biodegradable polymer as claimed in claim 1, wherein the second catalyst is selected from a group consisting of potassium per sulfate, ammonium per sulfate, lewis acids, hydrogen peroxide and other free radical initiators.

9. The water soluble biodegradable polymer as claimed in claim 1, wherein the phosphatide and the triglyceride are obtained from natural sources.

10. A process for preparation of a water soluble biodegradable polymer for calcium salt inhibition and sequestration in detergent and water treatment applications, the process comprising:
preparing a mixture of phosphatide and triglyceride;
reacting the mixture of the phosphatide and the triglyceride with an anhydride in an organic solvent with a first catalyst at an elevated temperature in the range of 100° C. to 160° C. for a duration ranging from one to three hours to form a reaction product;
hydrolyzing the reaction product;
separating the organic solvent from the reaction product;
adding a second monomer along with a second catalyst to the separated reaction product to form a reaction mass;
curing the reaction mass under stirring at a reflux temperature ranging from one to three hours to form a reaction mixture; and
cooling the reaction mixture and neutralizing the reaction mixture with a caustic solution to obtain the water soluble biodegradable polymer.

11. The process as claimed in claim 10, wherein the phosphatide is selected from a group consisting of phosphatidyl-choline, phosphatidyl-ethanol amine, phosphatidyl-inositol and phosphatilic acid in the range of 5 to 25 wt %.

12. The process as claimed in claim 10, wherein the triglyceride is selected from a group consisting of palmitic acid, stearic acid, oleic acid, linoleic acid and alpha-linolenic acid in the range of 5 to 39 wt %.

13. The process as claimed in claim 10, wherein the anhydride is selected from a group consisting of maleic anhydride, succinic anhydride and phthalic anhydride.

14. The process as claimed in claim 10, wherein the organic solvent is a high boiling non polar solvent having a boiling point in the range of 90° to 160° C.

15. The process as claimed in claim 10, wherein the first catalyst is selected from a group consisting of 2,5-Dimethyl-2,5-di t-butylperoxy hexane, t-butylperoxy-2-ethylhexanoate, t-butylperoxy benzoate, di-t-butyl peroxide and hydrogen peroxide.

16. The process as claimed in claim 10, wherein the second monomer is selected from a group consisting of acrylic acid, methacrylic acid and other carboxylic acids having a conjugated unsaturated bond.

17. The process as claimed in claim 10, wherein the second catalyst is selected from a group consisting of potassium per sulfate, ammonium per sulfate, lewis acids, hydrogen peroxide and other free radical initiators.

18. The process as claimed in claim 10, wherein the phosphatide and the triglyceride are obtained from natural sources.
